(19) United States
(12) Patent Application Publication
(10) Pub. No.: US 2026/0260779 A1
(43) Pub. Date: Sep. 3, 2026

(54) RIGID ELECTRICAL CONDUCTOR COMPRISING ELEMENTS CONNECTED TO ONE ANOTHER BY TIG WELDING, METHOD FOR THE PRODUCTION AND USE OF SUCH AN ELECTRICAL CONDUCTOR

(71) Applicant: COMMISSARIAT A L'ENERGIE ATOMIQUE ET AUX ENERGIES ALTERNATIVES, PARIS (FR)

(72) Inventors: Simon ALAMOME, GRENOBLE CEDEX 09 (FR); Michel PLANQUE, GRENOBLE CEDEX 09 (FR); Carmelo TRIPOLI, GRENOBLE CEDEX 09 (FR)

(73) Assignee: COMMISSARIAT A L'ENERGIE ATOMIQUE ET AUX ENERGIES ALTERNATIVES, PARIS (FR)

(21) Appl. No.: 18/865,932

(22) PCT Filed: May 17, 2023
(86) PCT No.: PCT/FR2023/050712

§ 371 Date: Nov. 14, 2024

(30) Foreign Application Priority Data
May 18, 2022 (FR) FR2204719

(51) Int. Cl. H01B 5/02; H01B 1/02; H01B 5/00; H01B 13/004; H01B 13/22

(52) U.S. Cl. CPC H01B 5/02; H01B 1/026; H01B 5/002; H01B 13/004; H01B 13/227

(57) ABSTRACT

The main subject matter of the invention is a rigid electrical conductor (70) comprising: an assembly (72) comprising a rigid conductive rod (74) made of a first metal material and a sheath (76) covering the conductive rod (74) and made of a second metal material having an electrical resistivity higher than the electrical resistivity of the first metal material; a first connection strip (78) formed at least in part by the second metal material and connected to a first end (72a) of the assembly (72), wherein, at the first end (72a) of the assembly (72), the conductive rod (74), the sheath (76) and the first connection strip (78) are bonded together by TIG welding with the addition of a material made of the second metal material.

### TECHNICAL FIELD

The present invention relates to the general field of high-temperature electrolysis (HTE), in particular high-temperature steam electrolysis (HTSE), carbon dioxide (CO₂) electrolysis, or high-temperature steam (HTE) and high-temperature carbon dioxide (CO₂) co-electrolysis.

More specifically, the invention relates to the field of high-temperature electrochemical devices, such as high-temperature solid oxide electrolysis cells, usually referred using the acronym SOEC, and high-temperature solid oxide fuel cells, usually referred to using the acronym SOFC, but also high-temperature water co-electrolysers with carbon dioxide, reversible high-temperature fuel cell and electrolyser systems, or so-called medium-temperature cells or electrolysers, in the region of 400° C., also known as PCFC for “Proton Ceramic Fuel Cell”.

Thus, more generally, the invention refers to the field of SOEC/SOFC type solid oxide cell stacks operating a high temperature. These stacks can operate at atmospheric pressure or under pressure.

Besides such SOEC/SOFC type solid oxide cell stacks, the invention is concerned by any system where there is a need for electrical conduction in a high-temperature oxidising environment or under conditions resulting in rapid degradation of electricity-conducting materials.

More particularly, the invention relates to the electric current supply of a stack of electrochemical cells in the hot zone.

### PRIOR ART

In the context of an SOEC type high-temperature solid oxide electrolyser, it is a matter of converting via an electric current, within the same electrochemical device, steam (H₂O) into dihydrogen (H₂) and dioxygen (O₂), and/or converting carbon dioxide (CO₂) into carbon monoxide (CO) and dioxygen (O₂). In the context of an SOFC type high-temperature solid oxide fuel cell, the operation is the opposite to produce an electric current and heat while being supplied with dihydrogen (H₂) or other fuels such as methane (CH₄), natural gas, biogas, and dioxygen (O₂), typically with air. For the purposes of simplicity, the following description privileges the operation of an SOEC type high-temperature solid oxide electrolyser carrying out steam electrolysis. However, this operation is applicable to carbon dioxide (CO₂) electrolysis, or high-temperature steam co-electrolysis (HTE) with carbon dioxide (CO₂). Furthermore, this operation can be transposed to the case of an SOFC type high-temperature solid oxide fuel cell.

As is known per se, a high-temperature steam (H₂O) electrolyser, or HTSE electrolyser, comprises a stack of several solid oxide elementary electrochemical cells. With reference to FIG. 1, a solid oxide cell 10, or “SOC” comprises in particular: a) a first porous conductive electrode 12, or “cathode”, intended to be supplied with steam for dihydrogen production; b) a second porous conductive electrode 14, or “anode”, whereby the dioxygen (O₂) produced by electrolysis of the water injected onto the cathode escapes; and c) a solid oxide membrane (dense electrolyte) 16 sandwiched between the cathode 12 and the anode 14, the membrane 16 being an anion conductor for high temperatures, usually temperatures greater than 600° C.

By heating the cell 10 at least to this temperature and injecting an electric current I to the anode 14, water reduction occurs on the cathode 12, which generates dihydrogen (H₂) at the cathode 12 and dioxygen (O₂) at the anode 14.

A stack 20 of such cells, having the aim of producing a substantial quantity of hydrogen, is illustrated by the schematic view of FIG. 2. In particular, the cells 10 are stacked on one another separated by interconnection plates 18 or interconnectors. These plates have the function of providing electrical continuity between the different electrodes of the cells 10, thus allowing an electrical serial connection thereof, and of distributing the different gases required for the operation of the cells, as well as where applicable a carrier gas to assist the evacuation of the electrolysis products and/or the thermal management of the stack.

For this purpose, the plates 18 are connected to a steam supply 22 for injecting this vapour on the cathodes of the cells 10 according to a constant steam flow rate D_{H2O} set by a controllable valve 24. The plates 18 are also connected to a gas manifold 26 for collecting the gases from electrolysis. An example of a stack and interconnection plate structure are for example described in international patent application WO 2011/110676 A1.

For the effective implementation of electrolysis by the stack 20, the stack is brought to a heat greater than 600° C., usually a temperature between 650° C. and 900° C., the gas supply is started up at constant flow rate and an electrical power supply source 28 is connected between two terminals 30, 32 of the stack 20 in order to circulate a current I therein.

The intensity I of the electric current is usually in the region of a few hundred amperes, which generates substantial heat losses by the Joule effect in electrical conductors. To optimise the energy efficiency of solid oxide electrochemical systems, it is necessary to limit these heat losses by developing in particular specific electrical conductors, also referred to using the expression “bus bars”.

A bus bar in the stack is generally presented in the form of a metal rod. Taking the example of a cylindrical rod, the electrical resistance R is expressed by the following formula:

$$R = ρ \cdot \frac{l}{S}$$

where ρ is the resistivity of the rod (in Ω·m), l is the length of the rod (in m), and S is the cross-section of the rod (in m²).

The Joule effect losses being proportional to the resistance R, to limit this effect, it is therefore necessary to reduce the electrical resistance of the bus bar. Possible optimisations therefore consist of:
limiting the length of the rod,
increasing its cross-section,
finding a material with a lower resistivity and stable at high temperatures.

The first two options are choices of geometry which are generally dependent on the shape of the electrochemical system. Therefore, there are constraints concerning and/or bus bars of the prior art are already optimised in relation to the electrochemical system. The final point relates to the constituent material of the rod that should be chosen with a minimal resistivity to reduce ohmic losses.

Optimising this final point has not been sufficiently taken into consideration. Indeed, for all laboratory developments of the technology, energy efficiency is not primordial. On the other hand, as explained hereinafter, a bus bar is immersed in a highly corrosive environment, such that the standard solution implemented consists of using solid non-oxidising alloy rods, which therefore represent the reference solution in all international publications. While the resistivity at ambient temperature (20° C.) of these rods is already high, in the region of 75.10⁻⁸ Ω·m, it should be noted that this resistivity increases substantially with temperature.

Thus, at 900° C., which is a high solid oxide electrolyser operating temperature, the electrical resistance of a stainless steel rod is equal to 117.10⁻⁸ Ω·m, which generates a very substantial ohmic loss. These aspects have in particular been described in French patent application FR 3 036 840 A1.

While it is sought however to optimise the electrical resistivity, the material generally recommended for electrical conductors subjected to a high electric current intensity is copper. An experimental study conducted by the Applicant made it possible to determine the resistivity curve of copper as a function of temperature and confirm that choosing copper makes it possible to reduce ohmic losses by at least a factor of 10 with respect to the reference material over the entire operating temperature range of solid oxide systems.

However, one of the substantial constraints that it is necessary to take into consideration is the problem of corrosion associated with the stack environment.

With reference to FIG. 3, the stack 20 is indeed enclosed in a so-called “thermal” chamber, the temperature of which is maintained between 65° and 900° C. under air scavenging, a conventional electrochemical system thus comprising:
the HTSE electrolyser 20, for example that described with reference to FIGS. 1 and 2 and comprising a set of ducts 52, 54, 56, 58 for supplying and collecting the gases from the anodes and cathodes of the electrochemical cells of the electrolyser;
a chamber 60 wherein the electrolyser 20 is housed, the ducts 52, 54, 56, 58 passing through a wall of the chamber 60 for their connection to gas supply and collection circuits (not shown). The chamber 60 also includes an air inlet duct 62, and an air outlet duct 64, the chamber 60 being for example hermetic to gases and liquids everywhere else. The duct 62 is capable of being connected to an air supply circuit (not shown) so as to apply air scavenging of the hot zone surrounding the electrolyser 20, the scavenging air being evacuated by the outlet duct 64; and
two electrical conductors 66, 68 connected to the terminals 30, 32 of the stack 20 and passing through the chamber 60 for their connection to the current source 28.

Under these conditions, two conductors 66, 68 in copper wire form, of which at least one part is comprised in the chamber 60, will oxidise very rapidly. Furthermore, copper does not resist oxidation at high temperatures because the oxide formed on the surface is not impervious and adherent enough to protect the underlying metal. The materials known to resist oxidation at high temperature are chromia- and alumina-forming alloys such as stainless steels and non-oxidising nickel alloys because they form chromia and/or alumina which are much more protective oxides. However, as stated hereinabove, these alloys have an electrical resistivity such that their use causes substantial energy losses.

A high-temperature solid oxide fuel cell (SOFC) experiences similar problems. Indeed, an HTSE electrolyser and an SOFC cell have identical structures, only their operating mode being different, the electrolyser operating in carbon dioxide (CO₂) reduction mode or in co-electrolysis mode, i.e. with a gas mixture at the cathode input composed of steam (H₂O) and carbon dioxide (CO₂). The mixture at the cathode outlet is then composed of hydrogen (H₂), steam (H₂O), carbon monoxide (CO) and carbon dioxide (CO₂). With reference to FIG. 4, an electrochemical cell consisting of an SOFC cell comprises the same elements (anode 12, cathode 14, electrolyte 16) as an electrolyser cell, the cell of the fuel cell being however supplied, with constant flow rates, on its anode with dihydrogen and on its cathode with dioxygen, and connected to a load C to deliver the electric current produced. With regard to the electric current produced, of several amperes, the fuel cell therefore experiences the same problems as the electrolyser.

One solution would be to protect a copper (or any other metal deemed appropriate in terms of electrical resistivity) rod with a coating to give it a good oxidation resistance, for example a chromia or alumina coating. This poses several problems. First of all, it is necessary to guarantee the imperviousness of the coating and its stability on the copper substrate during heating. It should be underlined that as copper has a high heat expansion coefficient, substantial differential heat expansion stress may appear and damage the coating and/or the coating/copper interface. Furthermore, at the hot end of the rod, it is necessary to make an electrical connection with the stack without exposing the copper. The connection must therefore be made on the coating, without damaging it, which is technically difficult.

Another solution is that of coating the copper rod in a sheath of oxidation-resistant material. In this way, the problem of resistance to differential heat expansion stress is solved because the two materials are not rigidly connected. Such an assembly (copper+non-oxidising sheath) is already known in the prior art for other fields of application (e.g. strong acid environment at low temperature, 50-80° C.), in particular from Chinese document CN 202608143 U which describes a copper bar which is simply threaded into a steel tube. This type of conductor is satisfactory at low temperatures and with a low temperature, but it has been observed that it was not suitable as is for solid oxide systems. Indeed, the weak contact between the conductor core and the sheath results, given the high temperature, in degradation of the electrical contact between the two materials and an increase in ohmic losses. In other words, in the prior art, there is no optimised electrical conduction system adapted to a strong electric current and withstanding substantial thermal in oxidising environments.

From patent application FR 3 036 840 A1, an electrical conductor is known, adapted to currents of several hundred amperes, resistant to oxidation at high temperatures and withstanding thermal cycling up to 900° C. This electrical conductor comprises a rod made of a first metal material and a sheath, covering the rod entirely, made of a second metal material, both being welded to one another using hot isostatic pressing (HIP).

More specifically, this application proposes to shape a rod composed of a round copper core protected by an Inconel® 600 type steel tune sheath, with a part called a “scarf joint” made of Inconel 600® type steel which is the connection terminal, and a closing endpiece also made of Inconel® 600 type steel whereby evacuation is performed. These parts are assembled with TIG (Tungsten Inert Gas) type arc welding. The bus bar obtained then enters a hot isostatic pressing (HIP) method, which makes it possible, without adding filler metal, to carry out diffusion bonding of the different materials together.

However, this solution has several drawbacks, in particular the use of hot isostatic pressing (HIP) which is a costly method and can only be carried out by specific companies, given a temperature and high-pressure cycle in the region of 900° C. and 1000 bar, with a cycle time of a few hours.

Furthermore, the bus bar consists of a single high-temperature connection area, which does not allow internal connections to be made at the high-temperature zone.

### DISCLOSURE OF THE INVENTION

The aim of the invention is to remedy at least partially the needs mentioned hereinabove and the drawbacks relating to embodiments of the prior art.

The subject matter of the invention is thus, according to one of its aspects, a rigid electrical conductor, comprising:
an assembly comprising:
   a rigid conductive rod made of a first metal material,
   a sheath covering the conductive rod and made of a second metal material, particularly non-oxidising or refractory, having an electrical resistivity higher than the electrical resistivity of the first metal material,
a first connection strip formed at least in part by the second metal material and connected to a first end of the assembly,

characterised in that, at the first end of the assembly, the conductive rod, the sheath and the first connection strip are bonded together by TIG (acronym of Tungsten Inert Gas) welding, in particular all along the circumference, with the addition of a material made of the second metal material.

“Rigid” electrical conductor means a conductor acting mechanically within a main link and not necessarily connected to a stack, as opposed to a “flexible” electrical conductor used for the connection to the stack, capable of preventing the transmission of vibrations, expansions and other parasitic movements between the stack and its environment and making it possible to make an optional electrical connection between stacks without mechanical transition. A rigid electrical conductor has a sufficient rigidity to hold in place.

The electrical conductor according to the invention may furthermore include one or several of the following features taken separately or according to any possible technical combinations.

Advantageously, the electrical conductor may include a second connection strip formed at in part by the second metal material and connected to a second end of the assembly. At the second end of the assembly, the conductive rod, the sheath and the second connection strip may be bonded together by TIG welding with the addition of a material made of the second metal material. The TIG welds at both ends of the assembly and the sheath may cover the conductive rod entirely all along its length.

Moreover, at least one gap may be present between the outer surface of the conductive rod and the inner surface of the sheath along at least a portion of the length of the conductive rod.

The conductive rod, first metal material, may be made of copper, nickel or silver and/or copper, nickel or silver alloys, or any other metal or alloy that is a good electrical conductor. In particular, any other metal or alloy that is a good electrical conductor sensitive to oxidation at high temperatures, in the region of 900° C., such as for example brass or bronze.

Furthermore, the sheath, second metal material, may be made of non-oxidising or refractory metal and/or metal or refractory alloys, in particular of stainless or refractory steel, for example based on nickel, chromium or cobalt, in particular of Inconel®, for example of Inconel® 600 or 625, or any other metal or alloy resistant to oxidation at high temperatures, for example 316L stainless steel.

The first connection strip and/or the second connection strip may be made entirely of the second metal material.

Alternatively, in order to limit any electrical losses, the first connection strip and/or the second connection strip may each include a conductive connection core made of the first metal material, and a connection sheath covering the connection core entirely all along its length and made of the second metal material.

The connection sheath may have a thickness in the region of 0.5 mm.

Moreover, the subject matter of the invention is also, according to another of its aspects, a method for manufacturing an electrical conductor as defined above, characterised in that it includes the following steps:
cleaning the surfaces, particularly by means of a detergent and/or a solvent, in particular the surfaces intended to be bonded, namely the electrical conduction surfaces and the surfaces required for the imperviousness of the electrical conductor,
inserting the conductive rod into the sheath,
bonding by TIG welding between the conductive rod and the first connection strip,
bonding by TIG welding between the sheath and the first connection strip,
optionally, evacuating the sheath by pumping.

As stated hereinabove, the electrical conductor may include a second connection strip formed at least in part by the second metal material and connected to a second end of the assembly, and the method may include, after the step of bonding by TIG welding between the sheath and the first connection strip, the following steps:
bonding by TIG welding between the conductive rod and the second connection strip,
bonding by TIG welding between the sheath and the second connection strip.

The manufacture may be carried out in ambient atmosphere (air) or in a neutral atmosphere, for example such as argon.

The first connection strip and/or the second connection strip may be formed by assembling a conductive connection core and a connection sheath covering the connection core entirely. The connection core may be manufactured by swaging. However, methods other than swaging could be used, such as machining or forging. The connection sheath may be manufactured by drawing or assembling several parts formed by the second metal material.

Moreover, the assembly of the first connection strip and/or the second connection strip may include at least the following steps:
cleaning the constituent elements of the connection strip, in particular using a detergent or a solvent,
inserting the connection core into the connection sheath,
evacuating the connection strip,
applying a Hot Isostatic Pressing (HIP) diffusion bonding cycle.

The Hot Isostatic Pressing (HIP) diffusion bonding cycle may be carried out with the following operating conditions:
bringing the assembly formed of the connection core and the connection sheath to a temperature between 600° C. and 1060° C., preferably between 800° C. and 1000° C., in particular a temperature of 920° C.,
applying to the connection sheath a pressure between 500 bar and 1500 bar, preferably between 800 bar and 1200 bar, in particular a pressure of 1020 bar,
applying a pressure and temperature plateau of a duration of 30 minutes to several hours, preferably 1 hour to 3 hours, in particular 2 hours,
allowing the assembly to cool and depressurise.

Furthermore, in order to guarantee a good electrical conductivity, the conductive rod and the connection core of the first connection strip and/or the second connection strip may be connected together with a high-temperature braze-welding or brazing method.

Furthermore, further subject matter of the invention, according to another of its aspects, is the use of at least one electrical conductor as defined above, as an electrical conductor of an electrochemical system including:
a chamber for circulating air in the volume delimited thereby,
an electrochemical device housed in the chamber, comprising:
   an SOEC/SOFC type solid oxide stack operating at high temperature, of elementary electrochemical cells each comprising an electrolyte inserted between a cathode and an anode and connected in series between two electrical terminals, and
   said at least one electrical conductor connected to at least one of the two electrical terminals.

Furthermore, further subject matter of the invention, according to another of its aspects, is an electrochemical system including:
a chamber for circulating air in the volume delimited thereby,
   an electrochemical device housed in the chamber, comprising:
   an SOEC/SOFC type solid oxide stack operating at high temperature, of elementary electrochemical cells each comprising an electrolyte inserted between a cathode and an anode and connected in series between two electrical terminals, and
   at least one electrical conductor as defined above, connected to at least one of the two electrical terminals.

### BRIEF DESCRIPTION OF THE FIGURES

The invention may be better understood on reading the following detailed description, of non-limiting implementation examples thereof, as well as on studying the schematic and partial figures of the appended drawing, wherein:

FIG. 1 is a schematic view of an elementary electrochemical cell of an HTSE electrolyser,

FIG. 2 is a schematic view of a stack of cells according to [FIG. 1],

FIG. 3 is a schematic view of a system incorporating a stack according to [FIG. 2],

FIG. 4 is a schematic view of an electrochemical cell of an SOFC fuel cell,

FIG. 5 is a schematic view of a conductor according to the invention,

FIG. 6 is a schematic sectional view along the plane VI-VI of [FIG. 5],

FIG. 7 is a schematic view of an electrical conductor according to the invention similar to that of [FIG. 5], the connection strips being of different design,

FIG. 8 is a schematic sectional view along the plane VIII-VIII of [FIG. 7],

FIG. 9 is a perspective and exploded view of a connection strip of the electrical conductor of [FIG. 7], and

FIG. 10 is a perspective assembled view of a connection strip of the electrical conductor of [FIG. 7].

In all of these figures, identical references may refer to identical or equivalent elements.

Furthermore, the different parts represented in the figures are not necessarily according to a uniform scale, to render the figures more readable.

### DETAILED DISCLOSURE OF SPECIFIC EMBODIMENTS

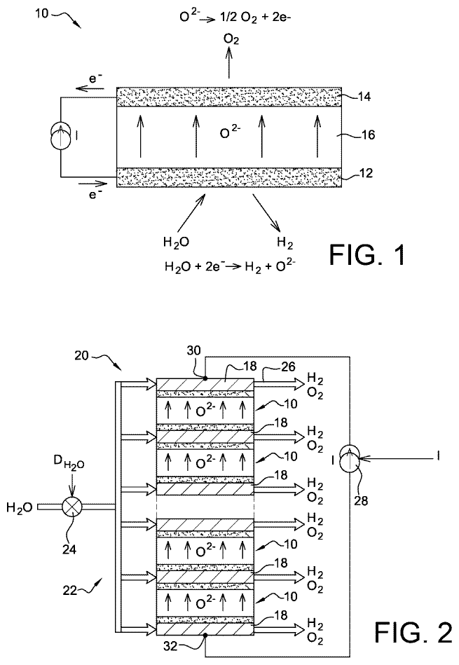

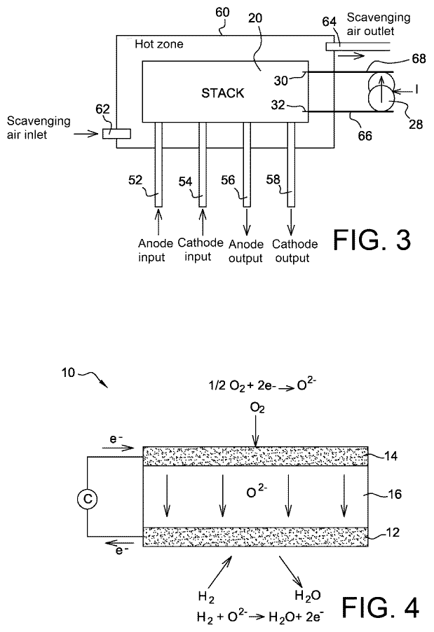

FIGS. 1 to 4 have already been described hereinabove in relation to the prior art and the technical context of the invention.

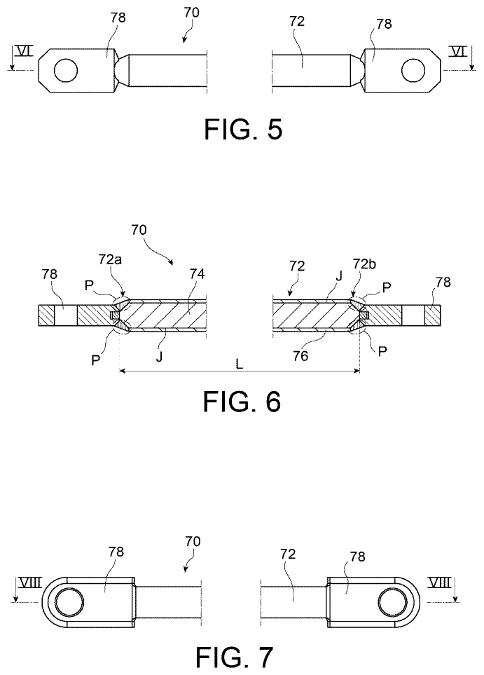

With reference to FIGS. 5 and 6, an example of an electrical conductor 70 according to the invention is described. It thus includes an assembly 72 composed of a conductive rod 74 made of a first metal material, here copper, inserted into a sheath 76, made of a second metal material, here of non-oxidising alloy such as Inconel®, having an electrical resistivity higher than the electrical resistivity of the first metal material.

It should be noted that the conductive rod 74 is here made of copper but the invention applies to other metals that are good electrical conductors but sensitive to oxidation, for example nickel, silver, brass, bronze and/or copper alloys, such as those hardened by dispersoids.

Furthermore, the electrical conductor 70 includes a first connection strip 78 made of the second metal material and connected to a first end 72a of the assembly 72, and a second connection strip 78 made of the second metal material and connected to a second end 72b of the assembly 72.

The connection strips 78, or “scarf joints”, here made of Inconel® type non-oxidising alloy hermetically block the ends 72a and 72b of the assembly 72, and thus prevent gas passage. They make it possible to create the electrical connection terminals. They have a complementary shape with the electrolyser plate on which the strips 78 are attached for the electric connection of the electrolyser.

The shape or geometry of the connection strips 78 may be the usual shape of a lug, as shown here, or any other different shape, for example cylindrical and intended to enter a hole of be clamped between two half-shells rigidly connected to the device to be supplied.

At the first end 72a of the assembly 72, the conductive rod 74, the sheath 76 and the first connection strip 78 are bonded together by TIG welding all along the circumference, represented by P in FIG. 6, for example an orbital weld, with the addition of a material made of the second metal material. Similarly, at the second end 72b of the assembly 72, the conductive rod 74, the sheath 76 and the second connection strip 78 are bonded together by TIG welding (reference P) with the addition of a material made of the second metal material. The TIG welds at the two ends 72a and 72b of the assembly 72 and the sheath 76 cover the conductive rod 74 entirely all along its length L, as seen in FIG. 6. The TIG weld makes it possible to protect the conductive rod 74 from oxidation. Indeed, the welding is carried out so as to render the connections between the scarf joints 78 and the sheath 76 impervious.

As shown schematically in FIG. 6, one or several gaps J may be present between the outer surface of the conductive rod 74 and the inner surface of the sheath 76 along at least a portion of the length L of the conductive rod 74. In particular, atmosphere may be trapped between the conductive rod 74 and the sheath 76, for example air, or an inerting atmosphere, for example argon.

In the case of air trapped between the sheath 76 and the conductive rod 74, during use, in particular at high temperatures, this air will be consumed by the oxidation of copper and that of Inconel®, but the volume being small and non-replenishable (imperviousness of the welds), the oxidation layer will remain very small. In the case of a neutral atmosphere, for example with argon scavenging, oxidation layer formation may be prevented.

It is also possible to evacuate the assembly 72 via a tube added for this purpose. A degassing tube is then added to one end and evacuation of the sheath is carried out by pumping via the tube. Pinching may then be carried out to hold the vacuum definitively, making it possible to seal the tube hermetically and definitively. Such an evacuation step may also make it possible to carry out an imperviousness check.

The non-oxidising alloy of the sheath 76 and connection strips 78 is chosen according to the thermal stress to which the electrical conductor 70 is exposed. In particular, for a temperature range of up to 900° C., the sheath 76 and the strips 78 may be made of Inconel® 600. The conductive rod 74 may have a diameter of some ten millimetres. However, the cross-section may be modified according to needs, for example in terms of current, voltage drop, etc.

The invention thus proposes to shape a rod 74 made of copper (or any other metal deemed satisfactory in terms of electrical resistivity) protected by a sheath 76 made of non-oxidising or refractory metal, in particular of stainless steel or non-oxidising nickel alloy, the whole bonded thanks to TIG welding with the presence of two connection strips 78. Therefore, the invention may thus be implemented without using a Hot Isostatic Pressing (HIP) method to allow the assembly between the rod 74, sheath 76 and connection strips 78.

Advantageously, the invention may therefore allow a reduced manufacturing cost, and also manufacturing simplicity allowing even the shaping and length adjustment directly on the site of use (shaping, cutting to length, scarf joint welding). The electrical conductor 70 (bus bar) may be used entirely in the high-temperature zone and also in the partition bushing allowing the link between the high-temperature zone and the ambient temperature zone.

The method for manufacturing such an electrical conductor 70, intended to be used as an electrical conductor for current distribution in an electrochemical system, for example that of FIGS. 1 to 4, includes for example the following steps:
manufacturing the parts described above (rod, sheath, strips),
cleaning the parts and in particular the surfaces intended to be bonded, namely the electrical conduction surfaces and the surfaces required for the imperviousness of the electrical conductor, by means of a detergent and/or a solvent, or any other means,
inserting the conductive rod 74 into the sheath 76,
bonding by TIG welding between the conductive rod 74 and the first connection strip 78,
bonding by TIG welding between the sheath 76 and the first connection strip 78,
bonding by TIG welding between the conductive rod 74 and the second connection strip 78,
bonding by TIG welding between the sheath 76 and the second connection strip 78,
where applicable, if required, evacuating the sheath 76 by pumping.

Furthermore, a weld X-ray step may be carried out in order to confirm the quality of the welds from a mechanical, electrical and imperviousness point of view.

The ends equipped with the strips 78 are hot ends that can be pierced, as seen in FIGS. 5 and 6, perpendicularly to the axis of the sheath 76, to be screwed onto the stack.

The TIG welds are advantageously produced by a person skilled in the art, in particular for the weld between copper and Inconel® in order to ensure that a good electrical connection is obtained, and for the weld between Inconel® and Inconel® in order to ensure that an impervious weld is obtained.

By comparing the resistance obtained for an electrical conductor 70 of 1 m, in Table 1 hereinafter, in the case of an electrical conductor 70 in 12 mm in diameter made entirely of Inconel® 600 (embodiment according to the prior art) and in the case of an electrical conductor 70 of 12 mm in diameter produced with a sheath 76 made of Inconel® 600 and a core 74 made of copper (embodiment according to the invention), it is observed that the invention makes it possible to reduce electrical losses by a factor of 10, at the temperature of use of 800° C.

TABLE 1

| | Inconel ® 600 | Inconel ® 600 + |
|---|---|---|
| | conductor 70 | copper conductor 70 |
| Temperature (° C.) | resistance (Ω) | resistance (Ω) |
| 20 | 9.1 · 10⁻³ | 0.21 · 10⁻³ |
| 800 | 10 · 10⁻³ | 0.87 · 10⁻³ |

For the results of this Table 1, the resistivity of copper is 17.24.10⁻⁹ Ω·m cold (20° C.) and 70.10⁻⁹ Ω·m at 800° C. The resistivity of Inconel® 600 is 1.03.10⁻⁶ Ω·m cold (20° C.) and 1.13.10⁻⁶ Ω·m at 800° C.

The rigid electrical conductor 70 obtained according to the principle of the invention is thus an electrical conductor adapted to the high temperature and high current of stacks of SOEC/SOFC type solid oxide cells. However, electrical losses may occur in the connection strips 78 and it is possible to modify the design of these connection strips 78 in order to limit these losses.

FIGS. 7 to 10 relate to another embodiment of a rigid electrical conductor 70 according to the invention wherein the connection strips 78 have a different design, then being referred to as “high-conductivity” connection strips 78 or scarf joints 78.

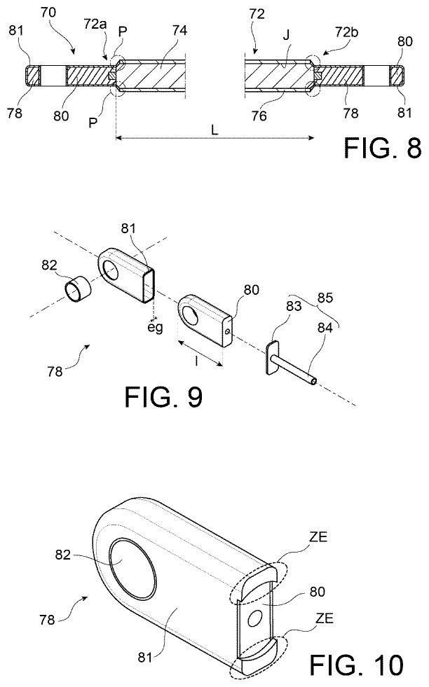

Specifically, the first connection strip 78 and the second connection strip 78 each include a conductive connection core 80 made of the first metal material, here copper but any other metal described hereinabove is possible, and a connection sheath 81 covering the connection core 80 entirely all along its length l, as seen in FIG. 9, and made of the second metal material, here Inconel® 600 but any other metal described hereinabove is possible. Advantageously, the connection sheath 81 has a thickness e_{g}, seen in FIG. 9, which is in the region of 0.5 mm. Obtaining a small thickness e_{g} significantly contributes to electrical loss reduction.

Furthermore, each connection strip 78 includes a tube forming a sleeve 82 inserted into corresponding bores of the connection core 80 and the connection sheath 81 to allow attachment to the stack, as seen in FIGS. 9 and 10.

The connection strip 78 obtained, as shown in FIGS. 9 and 10, makes it possible to reduce the electrical losses therein by replacing a portion of the second metal material by the first metal material having a good conductivity. Indeed, by keeping a connection sheath 81 made of Inconel® to protect the connection core 80 made of copper from oxidation, it is possible to reduce the electrical losses of the scarf joint 78. However, such a scarf joint 78 being the connection site, an electrical continuity on all of the connection surface is required between the connection sheath 81 and the connection core 80. For this, the method for manufacturing such a scarf joint 78, described hereinafter, uses the Hot Isostatic Pressing (HIP) method, used in the invention only for the manufacture of such “high-conductivity” scarf joints 78, in order to guarantee a weld of all of the connection surface between the connection core 80 and the connection sheath 81.

The electrical conductor 70 of the embodiment of FIGS. 7 and 8 therefore has a better conductivity than that described with reference to FIGS. 5 and 6, thanks to the use of “high-conductivity” connection strips 78. Specifically, a “high-conductivity” connection strip 78 may have a resistivity of only around ten percent relative to a connection strip 78 entirely made of the second metal material.

For the manufacture of “high-conductivity” connection strips 78, the connection core 80 may be obtained by swaging. Swaging forging consists of forming by plastic deformation after heating unwrought parts made of alloys, such as aluminium, copper, titanium, nickel alloys, etc. Steel swaging is also known as “stamping”. Swaging is a forging operation performed using tools called “dies”, in particular upper and lower half-dies. They contain a hollowed shape of the part to be manufactured.

Moreover, the connection sheath 81 may be obtained by drawing or assembling several parts made of the second metal material. This drawing manufacture technique makes it possible to obtain, from a planar sheet of sheet metal, an object for which the shape is not developable. This technique is adapted to serial production.

The method for assembling a “high-conductivity” connection strip 78 or “high-conductivity” scarf joint then comprises the following steps:
cleaning the constituent parts of the scarf joint 78, for example using detergents, solvents or any other suitable means,
inserting the connection core 80 into the connection sheath 81,
inserting the tube forming a sleeve 82, made of the first metal material,
bonding by TIG welding between the connection sheath 81 and the tube forming a sleeve 82 to render the joins on each face impervious, optionally with the addition of material, in particular composed of stainless steel,
adding the closing cover 85 formed by a closing plate 83 and a pinching tube 84, as shown in FIG. 9,
bonding by TIG welding between the connection sheath 81 and the closing cover 85 to render the join impervious,
evacuating the scarf joint 78, a vacuum pump being connected to the tube 84 so as to create the vacuum inside the connection sheath 81, then pinching of the tube 84 is carried out so as to seal it hermetically and definitively.

Subsequently, the application of a Hot Isostatic Pressing (HIP) diffusion bonding cycle is carried out with the following operating conditions:
bringing the assembly 78 formed inter alia of the connection core 80 and the connection sheath 81 to a temperature between 600° C. and 1060° C., preferably between 800° C. and 1000° C., in particular a temperature of 920° C.,
applying to the connection sheath 81 a pressure between 500 bar and 1500 bar, preferably between 800 bar and 1200 bar, in particular a pressure of 1020 bar,
applying a pressure and temperature plateau of a duration of 30 minutes to several hours, preferably 1 hour to 3 hours, in particular 2 hours,
allowing the assembly to cool and depressurise.

Finally, each “high-conductivity” connection strip 78 may undergo machining in order to allow connection directly of the connection core 80, and a scarf joint 78 as shown in FIG. 10 is obtained. Note that the two end zones ZE as shown in this FIG. 10 may be retained or machined.

The “high-conductivity” scarf joints 78 are then connected to the assembly 72 by a low-resistivity connection. In particular, the conductive rod 74 and the connection core 80 of each connection strip 78 may be connected by braze-welding or high-temperature brazing. A high-conductivity electrical connection is thus obtained. The choice of filler material may make it possible to guarantee the connection up to maximum temperatures of use in the region of 900° C. The mounting can be carried out for example the commercial solder Castolin® 146 and the recommended 146 M flux. This solder consists of 60% copper, 39% zinc and 1% tin-manganese.

Then, as described hereinabove, the mechanical connection and imperviousness are obtained by TIG welding, as shown in FIG. 8 at point P on all the circumference, with the addition of a material made of the second metal material. An optional evacuation step may be carried out and a weld and solder X-ray step may also be implemented as described hereinabove.

The embodiments described hereinabove with reference to FIGS. 5 to 10 make it possible to obtain rigid electrical conductors, based on the use of bus bars, adapted to the high temperature and the high currents of solid oxide cell stacks. They allow the transmission of an electric current for the main links with the lowest possible losses.

The invention may be applied to a high-temperature steam electrolyser, to a high-temperature co-electrolyser supplied with a mixture of steam (H₂O) and carbon dioxide (CO₂), to a high-temperature solid oxide fuel cell, to a reversible system, high-temperature fuel cell and electrolyser, to “medium-temperature”, i.e. 400° C., fuel cells or electrolysers, or Proton Ceramic Fuel Cells (PCFCs), as described hereinabove.

The invention applies to the systems described hereinabove operating at atmospheric pressure but also to pressurised systems.

Besides the technical field of solid oxide electrochemical systems, the invention applies to any fields for which there is a need for electrical conduction in a high-temperature oxidising environment or under conditions resulting in rapid degradation of electricity-conducting materials.

Obviously, the invention is not limited to the embodiments described hereinabove. Various amendments may be made thereto by a person skilled in the art.

1. A rigid electrical conductor, comprising:
an assembly comprising:
a rigid conductive rod made of a first metal material, and
a sheath covering the conductive rod and made of a second metal material having an electrical resistivity higher than the electrical resistivity of the first metal material, and
a first connection strip formed at least in part by the second metal material and connected to a first end of the assembly,
wherein, at the first end of the assembly, the conductive rod, the sheath and the first connection strip are bonded together by TIG welding with the addition of a material made of the second metal material.

2. The conductor according to claim 1, further comprising:
a second connection strip formed at least in part by the second metal material and connected to a second end of the assembly,
wherein, at the second end of the assembly, the conductive rod, the sheath and the second connection strip are bonded together by TIG welding with the addition of a material made of the second metal material, the TIG welds at both ends of the assembly and the sheath covering the conductive rod entirely all along its length.

3. The conductor according to claim 1, wherein at least one gap is present between the outer surface of the conductive rod and the inner surface of the sheath along at least a portion of the length of the conductive rod.

4. The conductor according to claim 1, wherein the conductive rod is made of copper, nickel, or silver and/or copper, nickel, or silver alloys.

5. The conductor according to claim 1, wherein the sheath is made of non-oxidising or refractory metal, and/or metal or refractory alloys.

6. The conductor according to claim 1, wherein the first connection strip and/or the second connection strip each include a conductive connection core made of the first metal material, and a connection sheath covering the connection core entirely all along it's a length of the connection core, and made of the second metal material.

7. A method for manufacturing an electrical conductor according to claim 1, the method comprising:
cleaning the surfaces by means of a detergent and/or a solvent,
inserting the conductive rod into the sheath,
bonding by TIG welding between the conductive rod and the first connection strip,
bonding by TIG welding between the sheath and the first connection strip, and
evacuating the sheath by pumping.

8. The method according to claim 7, wherein the electrical conductor includes a second connection strip formed at least in part by the second metal material and connected to a second end of the assembly, and in that the method further includes, after the step of bonding by TIG welding between the sheath and the first connection strip, the following steps:
bonding by TIG welding between the conductive rod and the second connection strip, and
bonding by TIG welding between the sheath and the second connection strip.

9. The method according to claim 7, wherein the first connection strip and/or the second connection strip are formed by assembling a conductive connection core and a connection sheath covering the connection core entirely, the connection core being manufactured by swaging and the connection sheath being manufactured by drawing.

10. The method according to claim 9, wherein the assembly of the first connection strip and/or the second connection strip comprises:
cleaning the constituent elements of the connection strip using a detergent or a solvent,
inserting the connection core into the connection sheath,
evacuating the connection strip, and
applying a Hot Isostatic Pressing (HIP) diffusion bonding cycle.

11. The method according to claim 10, wherein the Hot Isostatic Pressing (HIP) diffusion bonding cycle is carried out with the following operating conditions:
bringing the assembly formed of the connection core and the connection sheath to a temperature between 600° C. and 1060° C.,
applying to the connection sheath a pressure between 500 bar and 1500 bar,
applying a pressure and temperature plateau of a duration of 30 minutes to several hours, and
allowing the assembly to cool and depressurise.

12. The method according to claim 9, wherein the conductive rod and the connection core of the first connection strip and/or the second connection strip are connected together with a high-temperature braze-welding or brazing method.

13. A method of using the electrical conductor according to claim 1, as an electrical conductor of an electrochemical system including:
a chamber for circulating air in the volume delimited thereby, and
an electrochemical device housed in the chamber, comprising:
an SOEC/SOFC type solid oxide stack operating at high temperature, of elementary electrochemical cells each comprising an electrolyte inserted between a cathode and an anode and connected in series between two electrical terminals, and
said at least one electrical conductor connected to at least one of the two electrical terminals.

14. An electrochemical system, comprising:
a chamber for circulating air in the volume delimited thereby, and
an electrochemical device housed in the chamber, comprising:
an SOEC/SOFC type solid oxide stack operating at high temperature, of elementary electrochemical cells each comprising an electrolyte inserted between a cathode and an anode and connected in series between two electrical terminals, and
the electrical conductor according to claim 1, connected to at least one of the two electrical terminals.
